(19) United States
(12) Patent Application Publication
(10) Pub. No.: US 2002/0178013 A1
(43) Pub. Date: Nov. 28, 2002

(54) Customer guidance system for retail store

(75) Inventors: Beth Louise Hoffman, Mantorville, MN (US); John Matthew Santosuosso, Rochester, MN (US); Gordon James Smith, Rochester, MN (US); George Willard Van Leeuwen, Rochester, MN (US)

Correspondence Address: Dugan & Dugan, L.L.P., 18 John Street, Tarrytown, NY, 10591, US

(73) Assignee: International Business Machines Corporation

(21) Appl. No.: 09/863,105

(22) Filed: May 22, 2001

(51) Int. Cl. G06F 17/60

(52) U.S. Cl. 705/1; 705/27

(57) ABSTRACT

A computerized system guides a customer to the location of a product displayed for sale in a retail store. The customer enters a product code indicative of the product in which the customer is interested. The system then retrieves product location information for the product. The retrieved product location information is presented to the customer. This may be done by printing a map or location information at a customer's home computer in response to interaction with the retailer's web server computer. Alternatively, the customer may be guided by a portable computing device transported through the store by the customer. As another alternative, a customer's shopping list may be uploaded from a PDA to a store computer. The store computer then prints out for the customer product location information for items included in the shopping list.

### FIELD OF THE INVENTION

The present invention is concerned with computer systems that perform customer service functions in connection with retail stores.

### BACKGROUND OF THE INVENTION

On-line shopping has in recent years become a popular alternative to shopping in stores or through mail-order catalogs. Many customers appreciate the convenience of viewing product information and placing orders via their home computers. Sometimes, however, even customers who like to shop on-line are reluctant to purchase an item that they have not handled and seen in person. Because many brick-and-mortar retailers now have on-line catalog operations, it is possible for these customers to browse the on-line catalog, find one or more items they are interested in, and then travel to the nearest retail store of the proprietor of the on-line catalog to examine and then purchase items found through the on-line catalog. This practice may combine some of the best aspects of on-line and in-person shopping, since perusing the on-line catalog may be much more efficient than walking around the retail store to look for products of interest. However, even when the customer arrives at the retail store knowing which product or products he or she may wish to buy, based on a perusal of the on-line catalog, the customer is still faced with the problem of finding the product of interest in the retail store. With the very large size of some retail establishments, a considerable amount of time may be spent attempting to find the products in which the customer is interested. Inquiries of store personnel as to the locations of products may not be of great assistance, since many store employees are recent hires who may not be familiar with product locations.

It is known to provide a kiosk in a retail store, where the kiosk displays a menu of items available for sale in the store. When a customer selects an item from the menu, the kiosk displays information indicative of the location of the item in the store.

U.S. Pat. No. 6,000,610 discloses a system in which a list of items available at a store and respective aisle locations are stored on a floppy disk. The list of items is retrieved from the disk and displayed on the customer's home computer. The customer selects items from the list. The customer's computer then prints a store map showing the locations of the selected items.

The present inventors have now recognized that the in-store shopping experience can be improved for customers who also shop on-line.

### SUMMARY OF THE INVENTION

An aspect of the invention provides for a method of guiding a customer to a product available for sale in a retail store. The method includes entering at least one product code and retrieving product location information for at least one product corresponding to the entered at least one product code. The method further includes presenting the retrieved product information location to the customer. The product code may be entered via the Internet or via a device located at the retail store. The device located at the retail store may be a kiosk or a handheld device carried by the customer. (For the purposes of this specification and the appended claims, entering a product code does not include selecting an item from a menu displayed by a kiosk or a computer.) Alternatively, the device located at the retail store may be integrated with a shopping cart or a shopping basket. (For purposes of this specification and the appended claims, shopping carts and shopping baskets may be collectively referred to as “shopping containers”.) The product location information may be presented to the customer by printing it on a piece of paper at the retail store or at a location remote from the retail store, such as the customer's home. The location information may alternatively be presented to the customer by displaying it on a display screen of a device located at the retail store, or by audibly reproducing the location information. The item location information presented to the customer may include a walking route map to a location of the product in the retail store, and/or may include the number of an aisle in which the product is located.

Another aspect of the invention provides for a system for guiding a customer to a product available for sale in a retail store. This system includes a transportable computing device and a computer in communication with the transportable computing device. The computer is programmed to download to the transportable computing device product location information that is indicative of a location of the product in the retail store. The transportable computing device may be a handheld device or may be integrated with a shopping cart or a shopping basket. The transportable computing device may present the downloaded product location to the customer in the form of visual or audible information.

Another system for guiding a customer to a product available for sale in a retail store is provided in accordance with still another aspect of the invention. The system according to this aspect of the invention includes a portable computing device in which a shopping list is stored, and a computer in communication with the portable computing device. The system also includes a printer controlled by the computer to print product location information corresponding to items on the shopping list.

Computer program products may be provided in accordance with these and other aspects of the invention. The inventive program is carried by a medium readable by a computer (e.g., a carrier wave signal, a floppy disc, a hard drive, a random access memory).

The system and method of the present invention help to improve the customer's in-store shopping experience by providing computerized assistance in locating products within the store. This saves time that might otherwise be spent by the customer trying to locate the product.

Other objects, features and advantages of the present invention will become more fully apparent from the following detailed description of the preferred embodiments, the appended claims and the accompanying drawings.

### BRIEF DESCRIPTION OF THE DRAWINGS

FIG. 1 is a block diagram of computer equipment employed to perform the present invention;

FIG. 2 is a flow chart that illustrates a method performed in accordance with the invention;

FIG. 3 is a schematic block diagram of a system provided in accordance with an alternative aspect of the invention;

FIG. 4 is a flow chart that illustrates a method performed in accordance with the alternative aspect of the invention; and

FIG. 5 is a schematic block diagram of a system provided in accordance with still another aspect of the invention; and

FIG. 6 is a flow chart that illustrates a method performed in part with the system of FIG. 5.

### DETAILED DESCRIPTION OF PREFERRED EMBODIMENTS

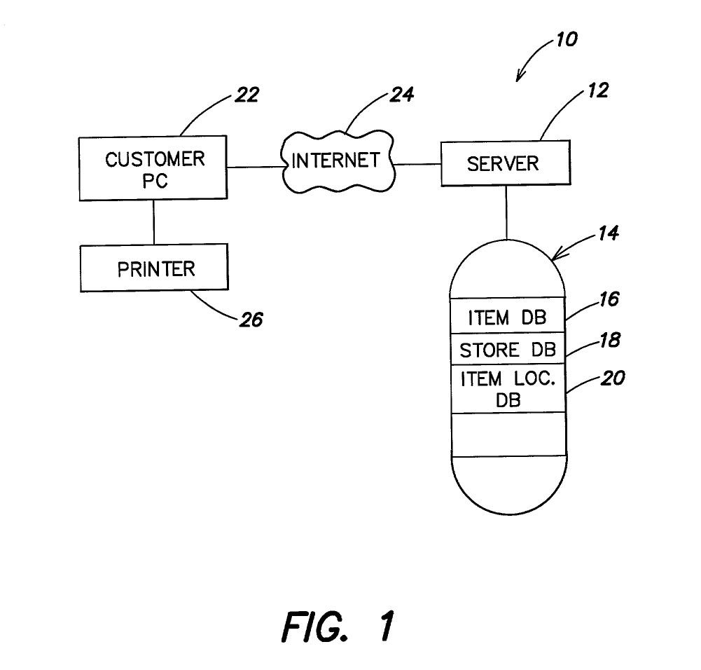

FIG. 1 is a block diagram representation of computer equipment that performs a method in accordance with a first aspect of the invention. The system illustrated in FIG. 1 is generally indicated by reference numeral 10. The system 10 includes a conventional web server 12 that is maintained by an operator of a retail store chain. Associated with the server 12 is mass storage 14. An item database 16, a store database 18 and an item location database 20 are stored in the mass storage 14.

The item database 16 stores information regarding products available for sale in the retail stores of the proprietor of the server 12 and/or available for sale via an on-line catalog maintained on the server 12. The store database stores data regarding store locations and other information concerning a chain of retail stores operated by the proprietor of server 12. The item location database 20 stores information that indicates where in the retail stores products are displayed for sale.

A conventional personal computer 22 is connected to the server 12 via the Internet 24. The PC 22 may be located at the home of a customer. A printer 26 is associated with the PC 22.

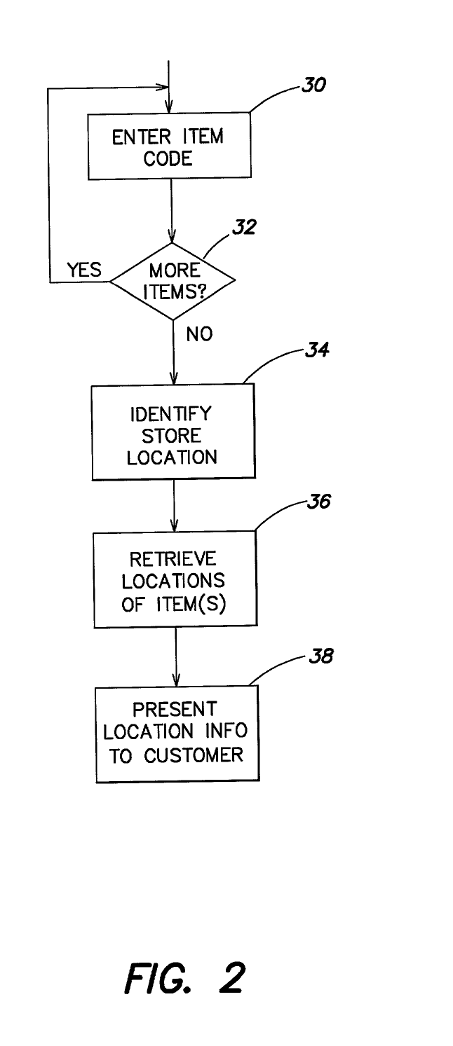

FIG. 2 is a flow chart that illustrates a process performed by interaction between the PC 22 and the server 12. For the purposes of FIG. 2, it is assumed that the PC 22 is logged on and is in communication with the server 12.

The process of FIG. 2 begins with step 30. At step 30 the customer enters a code corresponding to a product that the customer is interested in locating at a retail store of the chain of stores operated by the proprietor of the server 12. The product code may be entered in a number of ways. For example, the customer may have read the product code in a hard-copy catalog issued by the proprietor of the server 12, may have read the product code in a print advertisement sponsored by the proprietor of the server 12 or may have found the product code via on-line shopping. The product code may be a string of alphanumeric characters. The customer may enter the alphanumeric product code into the server 12 via the keyboard (not separately shown) of the PC 22. Alternatively, the customer may enter the product code by interacting with the server 12 to indicate selection of a product that is included in an online catalog maintained by the server 12.

Following step 30 is step 32, at which it is determined whether the customer is interested in locating additional products. If so, the process loops back to step 30. Otherwise, the process proceeds to step 34. The purpose of step 34 is to identify the store location at which the customer desires to find the products. As part of step 34, the customer may select a convenient store location from a list of store locations presented by the server 12. It will be understood that such locations are stored in the store database associated with the server 12. Alternatively, if the customer's location is known to the server 12, the server 12 may automatically identify the store location that is closest to the customer's home.

Following step 34 is step 36. At step 36 the server 12 retrieves from the item location database 20 the location of the product or products, corresponding to the product code or codes entered at step 30, in the retail store location identified at step 34. Then, at step 38, the product location information is presented to the customer via the PC 22.

It will be understood that the product location information is indicative of the location of the product within the retail store. The product location information may take a number of different forms and may be presented to the customer in a variety of ways. For example, the product location information may be the number of an aisle at which the product is located in the store. The aisle information may be printed on a sheet of paper by the printer 26 and/or may be displayed on a display screen (not separately shown) of the PC 22. Alternatively, the product location information may take the form of a map of the retail store in question, with the map having highlighted notations to indicate the locations of the products within the store. Data representing the map may be formulated by the server 12 and downloaded to the PC 22 for printing on the printer 26. If the customer is interested in more than one product, the map may indicate a walking route within the store that will guide the customer to the respective locations of the products that the customer is interested in. It is also contemplated to output the product location information from the PC 22 in audible form.

Although step 34, relating to identification of the desired store location, is indicated as being performed after entry of the product codes, it should be understood that this may be done before or between entry of the product codes.

A variation on the process illustrated in FIG. 2 may also be performed by means of a kiosk or terminal located at a retail store. It is assumed that the customer has read a product code from an on-line catalog, a hard copy catalog or a printed advertisement, and has written the product code on a piece of paper. The customer then proceeds to the retail store and enters the product code into a kiosk or terminal. According to this aspect of the invention, the product code is an alphanumeric string that is entered into the kiosk or terminal by keyboard entry. The kiosk itself may store a database of item locations in the store or may be connected to a computer which stores such a database. The location of the items may be retrieved from the database and presented to the customer via a display screen, by printing the information on paper via a printer associated with the kiosk, and/or by audibly reproducing the product information location. As before, the product information may indicate the aisle in which the product is located and/or may comprise a map of the store, highlighted to indicate the location of the product on the map. The map may also include an indication of a walking route for the customer to follow to be guided to the location of the product.

As an alternative to writing the product code on a piece of paper and carrying the piece of paper to the store, the product code or codes may be stored in a smart card, and the smart card transported to the store, at which the smart card is interfaced to a card reader included in the kiosk or terminal.

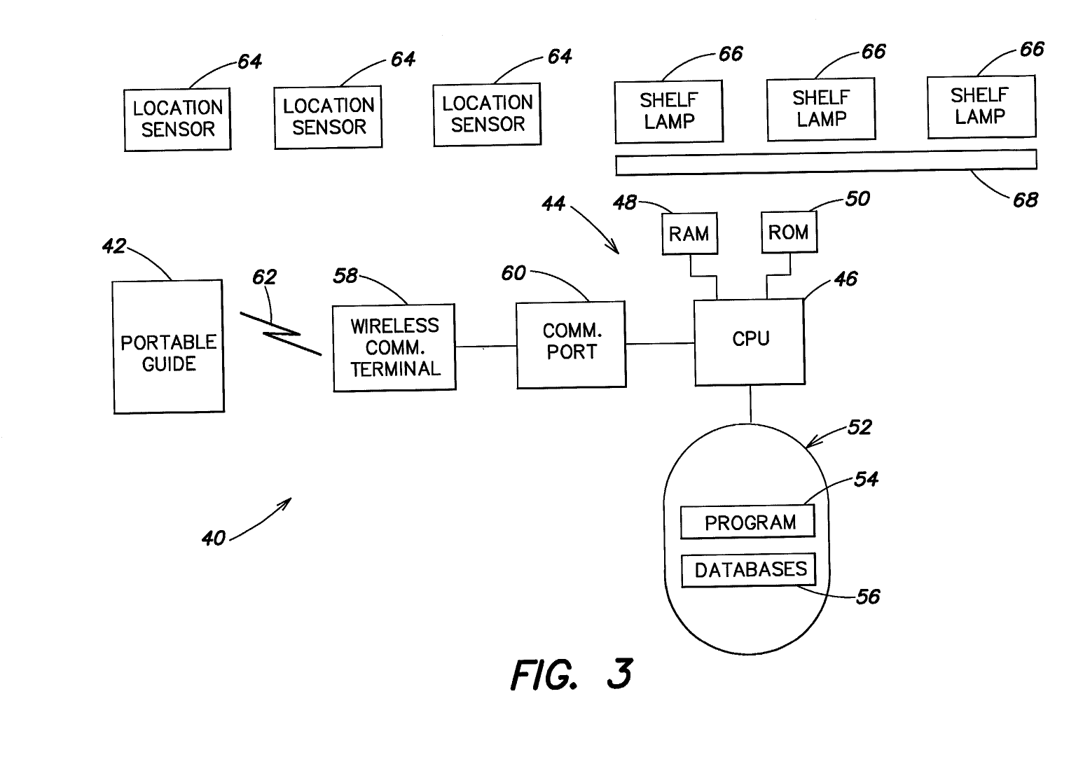

An alternative embodiment of the invention calls for the customer to be guided to a product location by means of a portable computing device transported by the customer through the retail store. FIG. 3 is a schematic illustration of a system 40 provided in accordance with this embodiment of the invention. The system 40 includes a portable computing device 42. The portable computing device 42 may take the form of a personal digital assistant (PDA), a laptop computer or a cellular telephone. Alternatively, the portable computing device 42 may be integrated with a shopping cart or a shopping basket. Like many conventional portable computing devices, the device 42 is capable of wireless data communication with other devices. The wireless data communication may be via a conventional protocol such as Bluetooth, or IEEE standard 802.11. A radio frequency identification (RFID) transponder may be integrated with the portable computing device 42. The portable computing device 42 may also include a card reader for reading information from a magnetic stripe of a credit card or other magnetic stripe card (e.g., for customer identification).

Reference numeral 44 indicates a computer maintained by the proprietor of the retail store. The computer 44 includes a central processing unit (CPU) 46, random access memory 48 and read only memory 50. Mass storage 52 is connected to the CPU 46. The mass storage 52 stores a program 54 for controlling the computer 44 and one or more databases 56, including a product location database and a customer database. The CPU 46 is connected to a wireless communication terminal 58 via a communication port 60. Through the wireless communication terminal 58 the computer 44 is able to communicate with the portable computing device 42 via a wireless communication channel 62.

The system 40 also includes location sensors 64 which are positioned at strategic locations in the retail store to detect the location of the portable computing device 42. For instance, the location sensors 64 may take the form of RFID readers positioned in each aisle of the store. The location sensors 64 are connected to computer 44 by means of signal connections which are not shown. The system 40 further includes annunciator lamps 66 installed on store shelves, of which only one shelf 68 is represented in the drawing. Each lamp 66 is arranged to be selectively illuminated in response to a control signal originating from the computer 44.

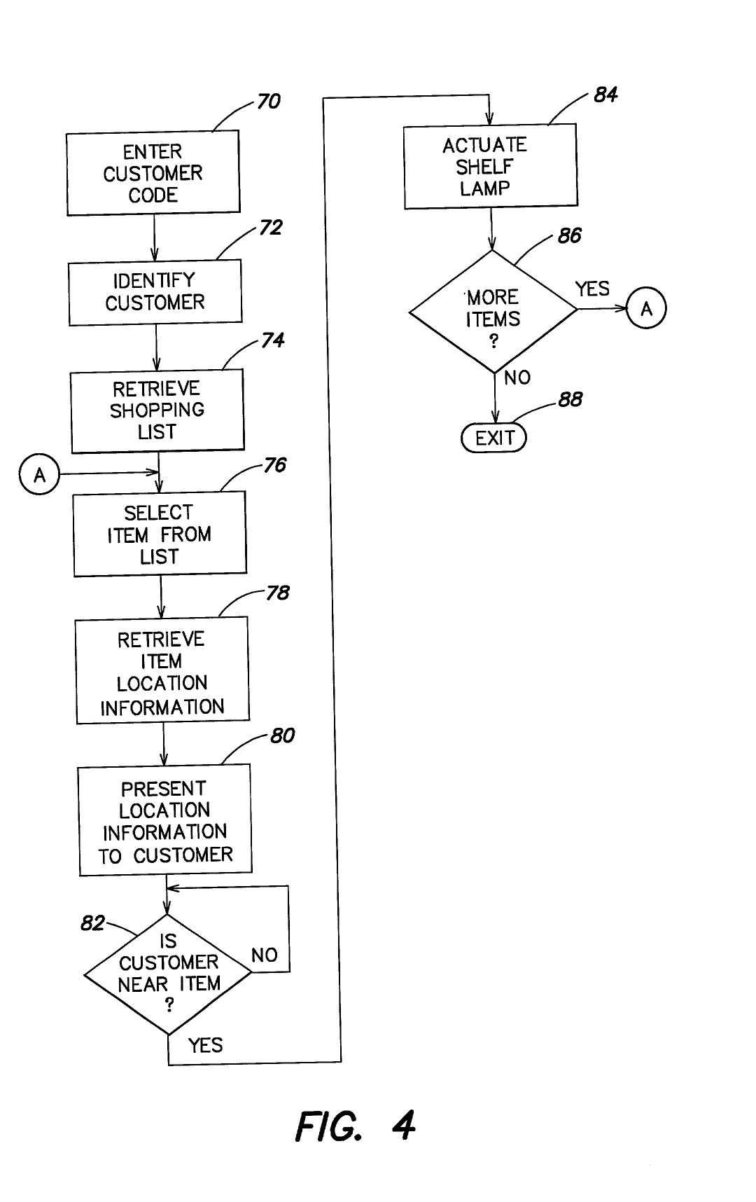

FIG. 4 is a flow chart that illustrates a process carried out by the system 40 according to this embodiment of the invention.

It is assumed for the purposes of FIG. 4 that the customer takes possession of a portable computing device 42 upon entering the retail store. As noted before, the portable computing device 42 may be a handheld object such as a PDA, or may be integrated with a shopping cart or a shopping basket. Alternatively, the portable computing device 42 may be a PDA that is owned by the customer and is brought to the retail store by the customer. In any event, the customer proceeds to travel through the store while transporting the portable computing device 42 with him or her.

It is also assumed for purposes of the process of FIG. 4 that prior to visiting the store, the customer has entered into the store computer a shopping list, i.e. a list of products that the customer is interested in purchasing at the store. This may have been done by the customer logging on to the store computer via the customer's home computer. Alternatively, the customer may have entered the shopping list into a website maintained by the operator of the retail store, and the shopping list may have been downloaded from the web server to the store computer.

The process of FIG. 4 begins with step 70 at which the customer enters information to identify himself or herself to the system 40. This may be done, for example, by swiping a credit card or a magnetic stripe identification card issued by the store through a card reader included in the portable computing device 42. Alternatively, the customer may enter alphanumeric information via a keypad included in the portable computing device 42.

Following step 70 is step 72. At step 72 the computer 44 identifies the customer on the basis of the customer code that was entered at step 70. Then, at step 74, the computer 44 retrieves the shopping list that was entered into the computer 44 prior to the customer visiting the store. Some or all of the items from the shopping list are then downloaded from the computer 44 to the portable computing device 42. The customer is then prompted to select one of the downloaded items by actuating a button or interfacing a stylus to a touch screen included in the portable computing device 42. Upon the customer's selecting an item (step 76) the selection of the item is communicated from the portable computing device 42 to the computer 44, and the computer 44 then retrieves the location for the item from the mass storage 52 (Step 78). The location of the item may be represented as the number of an aisle in which the item is located. The location information is then downloaded from the computer 44 to the portable computing device 42, and the location information is presented to the customer by the portable computing device 42 (Step 80). For example, the portable computing device may display to the customer a message such as “Go to aisle 5”. Alternatively, this message may be audibly reproduced by the portable computing device 42.

Following step 80 is step 82, at which it is determined whether the customer is near the item selected at step 76. Detecting proximity of the customer to the selected item may be performed by the location sensors 64 (FIG. 3) detecting the location of the portable computing device 42, or, more specifically, by detecting an RFID transponder incorporated in the portable computing device 42. Thus, when a location sensor 64 located in the same aisle as the selected item is able to read the RFID transponder of the portable computing device 42, this fact is communicated to the computer 44. The computer 44 then actuates the annunciator lamp 66 which is nearest on the shelf 68 to the selected product (Step 84). The actuated shelf lamp 66 then flashes to draw the attention of the customer to the selected product.

Following step 84 is step 86, at which it is determined whether additional items remain on the shopping list. If so, the process of FIG. 4 loops back to step 76. Otherwise, the process ends (step 88).

The process of FIG. 4 may be modified in a number of ways, including the addition of some functions. For example, the customer may be prompted through the portable computing device 42 to enter an indication when the customer has found the selected item.

The system 40 may also operate to promote the sale of products that are not included in the customer's shopping list. This may be done by displaying suitable messages on the portable computing device 42, such as “Christmas decorations, now on sale, aisle 6”. The item or items selected for promotion may be determined on the basis of a number of factors including one or more of the following: the customer's location in the store, the parts of the store that the customer has visited, items that have been purchased by the customer, demographic factors related to the customer, such as age, gender, credit rating, and so forth.

When the store is crowded it may be desirable to disable the annunciator lamps, to avoid confusing several customers who may be in the same aisle at the same time seeking different products. It is also contemplated to omit the location sensors 64 and the shelf lamps 66 from the system 40.

Instead of requiring the customer to select items from the shopping list, as indicated at step 76, the system 40 may automatically retrieve location information for the entire shopping list and download the information to the portable computing device 42. For example, the following messages could be displayed on the portable computing device 42 in response to communications from the computer 44: “Socks—aisle 3. Shoes—aisle 5. Gloves—aisle 7.”

From the foregoing it will be seen that the present invention guides the customer through the store based on shopping list data or other information that the customer has entered through interaction with a web server or other computer maintained by the proprietor of the store. The guidance provided by the inventive system makes the shopping experience more convenient, and aids the customer in locating within the store items of interest to the customer. Thus, some of the advantages of on-line shopping are combined with an in-store shopping experience.

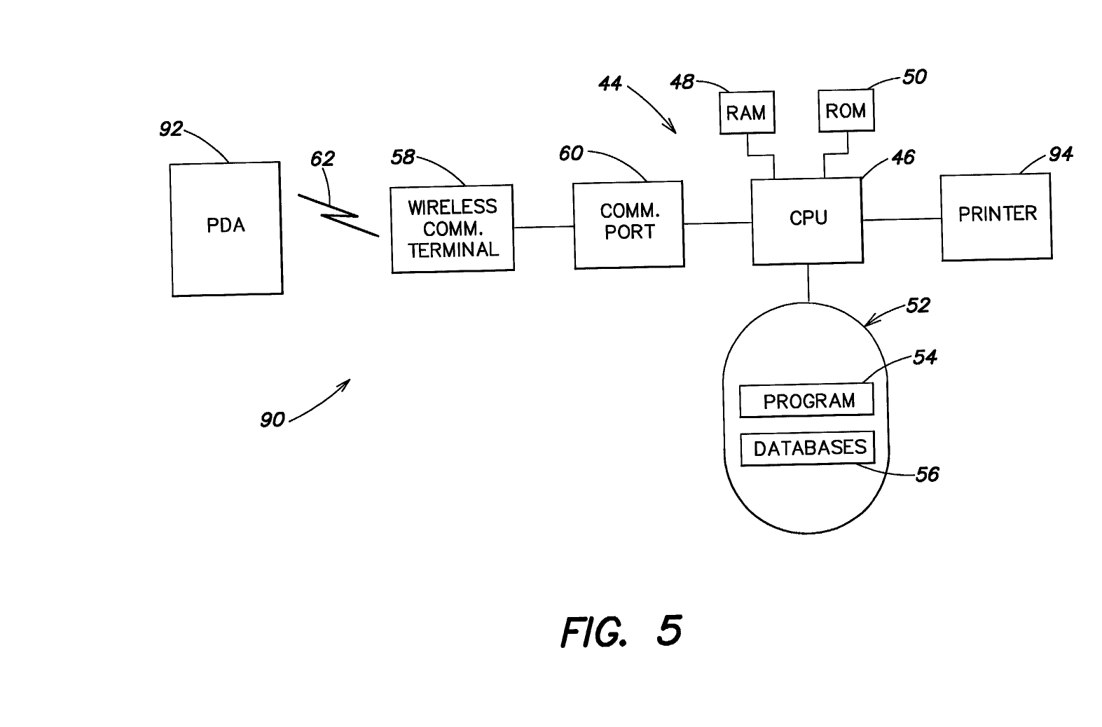

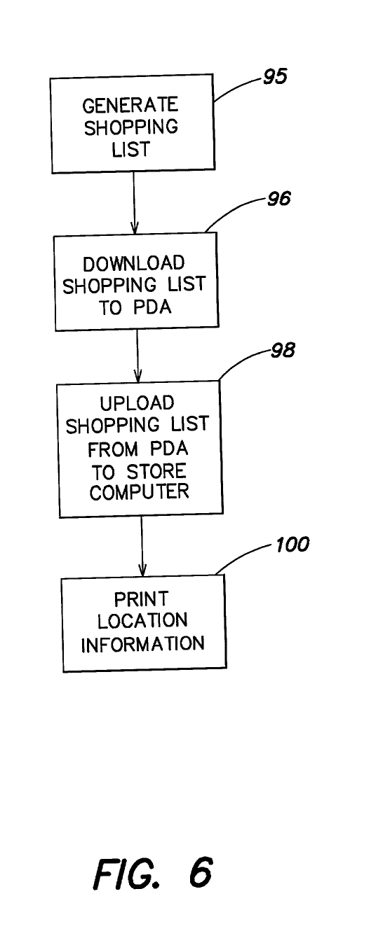

Another aspect of the invention will now be described with reference to FIGS. 5 and 6.

FIG. 5 is a schematic block diagram illustration of a system 90 provided in accordance with this further aspect of the invention. The system 90 includes a portable computing device such as PDA 92. The PDA 92 is shown to be in wireless communication with a computer 44, which may be like the computer described in conjunction with FIG. 3, but with the addition of a printer 94 controlled by the computer 44. The printer 94 may be co-located with the wireless communication terminal 58 through which the computer 44 communicates with the PDA 92.

FIG. 6 is a flow chart that illustrates a method performed in accordance with this aspect of the invention.

Initially in the method of FIG. 6 is a step 95, at which a customer generates a shopping list. This may be done by using a software package installed on the customer's home computer (not shown). The shopping list may be constituted by generic items, such as “milk, orange juice, bread”, etc. and/or may include specific items including a product code that indicates a specific stock keeping unit (SKU).

Once the shopping list has been generated, it is downloaded from the customer's home computer to the PDA 92 (step 96). (Alternatively, the shopping list may have been generated directly on the PDA 92 at step 95, in which case step 96 is omitted.) After the shopping list is downloaded to the PDA 92, the customer travels to the retail store, bringing along PDA 92. At the store the customer initiates data communication between the PDA 92 and the computer 44 via the wireless communication terminal 58. The shopping list stored in the PDA 92 is uploaded to the computer 44 (step 98). The computer 44 then retrieves from one of the databases 56 product location information corresponding to the items on the uploaded shopping list and causes the printer 94 to print the retrieved product location information (step 100).

The printed product location information may take a number of forms. For example, the printout may include the shopping list itself with an appropriate aisle number indicated adjacent to each item on the shopping list. The list may be reorganized to group items according to their location. Alternatively, the printed product location information may include a store map showing the aisles of the store, and indicating in conjunction with each aisle which items from the shopping list are located in that aisle. The map could also include arrows or a walking path route to direct the shopper through the store using the most efficient path based on the aisles or areas of the store at which the items from the shopping list are located.

The printout from the printer 94 may include information in addition to product location information. For example, the customer's home computer software may have permitted the customer to enter a quantity for one or more shopping list items. This information may be downloaded to the PDA 92 and then uploaded to the store computer 44. The quantity information may, in turn, be printed on the same paper with the product location information, e.g., “paper towels—Aisle 5—2 rolls”.

As another example, the customer's home computer software may allow entry of a specific brand for each item. This information, after being downloaded to the PDA 92 and then uploaded to the store computer 44, can be used by the store computer 44 to determine whether or not the brand is available at the store. If the brand is not available, the printout from the printer 94 may indicate the unavailability of the customer's selected brand and may suggest alternative brands. This would save the customer from searching for the unavailable brand and not finding it on the store shelf.

Where the shopping list item is generic, e.g., “cereal”, the printout from the printer 94 could indicate what brand or brands are on sale, out of stock, available at the lowest cost, and so forth. Thus, information printed together with product location information may include “comparison shopping information” by which is meant information that indicates whether an item from the shopping list is on sale and/or that one brand is cheaper than another brand. Accordingly, the printout from the printer 94 may provide the customer with useful information for decision making, in addition to guidance on where to find the items on the shopping list.

The location of each item may be indicated with a finer granularity than aisle-by-aisle. For example, the printout may indicate the particular side of the aisle at which the product is located, or even a section within an aisle.

The system provided in accordance with this aspect of the invention again uses computer technology to help a customer locate items from a shopping list within a retail store, thereby saving the customer time and avoiding frustration.

The foregoing description discloses only the preferred embodiments of the invention; modifications of the above disclosed apparatus and methods which fall within the scope of the invention will be readily apparent to those of ordinary skill in the art. While the present invention has been disclosed in connection with the preferred embodiments thereof, it should be understood that other embodiments may fall within the spirit and scope of the invention, as defined by the following claims.

The invention claimed is:

1. A method of guiding a customer to a product available for sale in a retail store, the method comprising the steps of:
entering at least one product code;
retrieving product location information for at least one product corresponding to the entered at least one product code; and
presenting the retrieved product location information to the customer.

2. The method of claim 1, wherein the at least one product code is entered via the Internet.

3. The method of claim 1, wherein the at least one product code is entered via a device located at the retail store.

4. The method of claim 3, wherein the at least one product code is entered via a kiosk located at the retail store.

5. The method of claim 3, wherein the device located at the retail store is a handheld device carried by the customer.

6. The method of claim 3, wherein the device located at the retail store is integrated with a shopping container.

7. The method of claim 1, wherein the presenting step includes printing the location information on a piece of paper.

8. The method of claim 7, wherein the printing occurs at the retail store.

9. The method of claim 7, wherein the printing occurs at a location remote from the retail store.

10. The method of claim 1, wherein the presenting step includes displaying the retrieved location information on a display screen of a device located at the retail store.

11. The method of claim 10, wherein the device located at the retail store is a kiosk.

12. The method of claim 10, wherein the device located at the retail store is a handheld device carried by the customer.

13. The method of claim 10, wherein the device located at the retail store is integrated with a shopping cart.

14. The method of claim 10, wherein the device located at the retail store is integrated with a shopping basket.

15. The method of claim 1, wherein the presenting step includes audibly reproducing the retrieved location information.

16. The method of claim 1, wherein the retrieved location information presented to the customer includes a walking route map to a location of the at least one product.

17. The method of claim 1, further comprising the step of selecting a store location for which the product location information is to be retrieved.

18. The method of claim 1, wherein the retrieved and presented product location indicates a store aisle in which the at least one product is located.

19. A system for guiding a customer to a product available for sale in a retail store, comprising:
a transportable computing device;
a computer in communication with the transportable computing device and programmed to download to the transportable computing device product location information that is indicative of a location of the product in the retail store.

20. The system of claim 19, wherein the transportable computing device is a handheld device.

21. The system of claim 19, wherein the transportable computing device is integrated with a shopping container.

22. The system of claim 19, wherein the transportable computing device presents the downloaded product location to the customer in the form of visual information.

23. The system of claim 19, wherein the transportable computing device presents the downloaded product location to the customer in the form of audible information.

24. The system of claim 19, wherein the product location information indicates an aisle in which the product is located.

25. The system of claim 19, further comprising means for determining a location of the transportable computing device in the retail store.

26. A system for guiding a customer to a product available for sale in a retail store, comprising:
entry means for entering at least one product code;
retrieval means, responsive to the entry means, for retrieving product location information for at least one product corresponding to the entered at least one product code; and
presentation means, responsive to the retrieval means, for presenting the retrieved product location information to the customer.

27. The system of claim 26, wherein the entry means includes a personal computer connected to the Internet.

28. The system of claim 27, wherein the presentation means includes a printer connected to the personal computer.

29. The system of claim 26, wherein the retrieval means includes a server computer connected to the Internet.

30. The system of claim 26, wherein the entry means includes a kiosk located at the retail store.

31. The system of claim 30, wherein the presentation means includes a display screen of the kiosk.

32. The system of claim 30, wherein the presentation means includes a printer associated with the kiosk.

33. The system of claim 26, wherein the presentation means includes a computing device transported within the retail store by the customer.

34. The system of claim 33, further comprising means for detecting a location of the computing device in a retail store.

35. The system of claim 26, wherein the entry means includes a portable computing device.

36. The system of claim 35, wherein the presentation means includes a printer located at the retail store.

37. The system of claim 36, wherein the retrieval means includes a computer located at the retail store.

38. A system for guiding a customer to a product available for sale in a retail store, comprising:
a portable computing device in which a shopping list is stored;
a computer in communication with the portable computing device; and
a printer controlled by the computer to print product location information corresponding to items on the shopping list.

39. The system of claim 38, wherein the portable computing device is a PDA.

40. The system of claim 38, wherein the computer is in wireless communication with the portable computing device.

41. The system of claim 38, wherein the product location information is printed in the form of a map of the retail store.

42. A method of guiding a customer to a product available for sale in a retail store, the method comprising the steps of:
uploading a shopping list from a portable computing device to a computer;
retrieving product location information for items included in the uploaded shopping list; and
presenting the retrieved product location information to the customer.

43. The method of claim 42, wherein the presenting step includes printing the retrieved product location information.

44. The method of claim 43, wherein the printed product location information is in the form of a map of the retail store.

45. The method of claim 44, wherein the map includes an indication of a path for the customer to follow.

46. The method of claim 43, wherein a quantity of at least one item of the shopping list is printed together with the retrieved product location information.

47. The method of claim 43, wherein an indication that an item of the shopping list is not available is printed together with the retrieved product location information.

48. The method of claim 47, wherein an indication of an alternative to the unavailable item is printed together with the retrieved product location information.

49. The method of claim 43, wherein comparison shopping information for at least one item of the shopping list is printed together with the retrieved product location information.

50. A computer program product comprising:
a medium readable by a computer, the computer readable medium having computer program code adapted to:
receive entry of at least one product code;
retrieve product location information for at least one product corresponding to the received at least one product code; and
present the retrieved product location code to a customer.

51. A method of guiding a customer to a product available for sale in a retail store, the method comprising the steps of:
selecting a product from an on-line catalog;
retrieving product location information for the selected product; and
presenting the retrieved product location information to the customer.

52. The method of claim 51, further comprising selecting a store location.
